(19) United States
(12) Patent Application Publication
(10) Pub. No.: US 2024/0124684 A1
(43) Pub. Date: Apr. 18, 2024

(54) Crystallizable Oxamide with Long Chains For Use as an Additive for Thermoplastic Polymers

(71) Applicant: TE Connectivity Solutions GmbH, Schaffhausen (CH)

(72) Inventors: Lei WANG, San Jose, CA (US); Ting GAO, Palo Alto, CA (US); Dejie TAO, Fremont, CA (US); Hyo Chang YUN, San Jose, CA (US)

(73) Assignee: TE Connectivity Solutions GmbH, Schaffhausen (CH)

(21) Appl. No.: 18/462,459

(22) Filed: Sep. 7, 2023

Related U.S. Application Data
(60) Provisional application No. 63/377,580, filed on Sep. 29, 2022.

(51) Int. Cl. C08K 5/20; H01R 13/46

(52) U.S. Cl. CPC C08K 5/20; H01R 13/46

(57) ABSTRACT

A novel additive comprising an oxamide additive with long chains is described herein. The additive can be incorporated into a thermoplastic polymer to form a thermoplastic polymer composite. The additive modifies the surface of the thermoplastic polymer to render the oil, water or dust repellent properties to the thermoplastic polymer composite.

### CROSS REFERENCE TO RELATED APPLICATIONS

This application Claims priority to U.S. Provisional Patent Application Ser. No. 63/377,580 filed on Sep. 29, 2022 which is incorporated herein by reference in its entirety.

### FIELD OF THE INVENTION

The present invention is directed to a novel family of additives of crystallizable oxamides having a variable long chains for use in thermoplastic polymer composites. These oxamide additives can provide improved surface properties of the thermoplastic composite, while still maintaining the mechanical properties of the thermoplastic polymer.

### BACKGROUND OF THE INVENTION

Thermoplastic composites have been used for various products, including electrical connectors due to good mechanical performance, good dielectric performance and low cost in processing. However, these composites can be easily contaminated due to their relatively high surface energy and hydrogen bonding in the material.

Converting the surface of the thermoplastic composite into a lower energy surface and/or into a more hydrophobic surface could potentially solve some of these contamination issues. Several different approaches have been used to overcome these issues without great success.

For example, the surface of the thermoplastic composite can be provided with a nano or micro textured pattern on the surface the thermoplastic composite. The provision of this type of pattern can result in a product that costs more due to capital needed to change the molds for the thermoplastic composite. The micron pattern may not be effective in preventing contamination of the thermoplastic composite.

Another possible option to avoid contamination issues is to modify the surface of a thermoplastic composite. The surface of the thermoplastic additive can be modified by the addition of a hydrophobic additive to the thermoplastic composite. A hydrophobic additive is an additive that repels water. When used in the thermoplastic composite, it causes any water on the surface of the composite to bead. The hydrophobic additive can also migrate to the surface of the thermoplastic composite as it has a lower surface energy than the thermoplastic composite itself. Due to this possible migration, the hydrophobic additive may not be durable in the thermoplastic composite. Examples of suitable hydrophobic additives are polymers with a surface contact angle of water above 80 degrees, such as, for example, but not limited to, polyamide 11, polyvinylidene fluoride, and polyvinyl fluoride. Other examples of hydrophobic additives, include but are not limited to polymers such as polyethylene, polychlorotrifluoroethylene, polydimethylsiloxane, fluorinated ethylene propylene polymer, poly(tetrafluoroethylene); hydrocarbon waxes such as paraffin wax, stearic acid, sodium octadecane-1-sulphonate, and trimethylstearylammonium chloride; fluorinated waxes such as but not limited to dialkyl amide perfluoropolyether derivatives; hydrocarbon silicone waxes such as but not limited to a triblock copolymer of ethylene and polydimethylsiloxane; fluoroalkylsilanes, polysiloxanes, fluorinated chemical and silane modified powders.

U.S. Patent Publication No. 2006/0088678A1 describes a dual ovenable film having a first layer comprising one or more polyamides and a second layer including one or more polyamides. The one or more layers may include one or more additives useful in packaging films, such as, antiblocking agents, slip agents, antifog agents, colorants, pigments, dyes, flavorings, antimicrobial agents, meat preservatives, antioxidants, fillers, radiation stabilizers, and antistatic agents. Such additives, and theft effective amounts, are known in the art.

U.S. Patent Publication No. 2007/0166513A1 describes patterned coatings having extreme wetting properties and methods of making. The patent publication describes a patterned surface comprising a substrate supporting a coating including a polyelectrolyte multilayer, wherein the surface includes a super hydrophilic region.

U.S. Patent Publication No. 2011/0223212A1 describes a nanotextured super hydrophobic coating that contains bioactive agents, such as antimicrobials. With the release of the bioactive agent from the coating, reduction of or elimination of bacteria is accomplished.

U.S. Patent Publication No. 2019/0091950A1 teaches a composite having a textured surface with multiple protrusions. The composite can be used as a structural coating.

U.S. Pat. No. 10,953,432 describes a superhydrophobic surface. The superhydrophobic surface is formed by growing a plurality of etchable, sacrificial structures, and depositing a discontinuous hydrophobic material onto the sacrificial structures. The discontinuity facilitates etching of the sacrificial structures to remove the grown structures while leaving the deposited materials intact to result in surface features for achieving superior hydrophobic properties.

It would, therefore, be beneficial to have a novel oxamide additive with long chains which can modify the surface of the thermoplastic polymer it is incorporated into, in order to provide good water, oil or dust repellent properties while still maintaining the desired physical properties of the thermoplastic polymer. Furthermore, it would be beneficial if the long chain on the oxamide additive can be further modified with various functional groups to provide additional desired properties to the thermoplastic polymer composite.

### SUMMARY OF THE INVENTION

An embodiment is directed to a novel oxamide additive with long hydrocarbon chains which can be incorporated into a thermoplastic polymer composite to provide good water, oil or dust repellent properties to the thermoplastic polymer composite while still maintaining the physical properties of the thermoplastic polymer.

An embodiment is directed to the process of making a thermoplastic polymer composite comprising a thermoplastic polymer and an oxamide additive, wherein said thermoplastic polymer composite has improved repellant properties.

Yet a further embodiment is directed to the use of a thermoplastic polymer composite with a crystallizable oxamide with a long hydrocarbon chain in an electrical connector.

Other features and advantages of the present invention will be apparent from the following more detailed description of the illustrative embodiment, which illustrates, by way of example, the principles of the invention.

### FIGURES

FIG. 1 is a graph showing the water contact angle of various polyamide polymer composites having a range of from 2% by weight to about 5% by weight of an oxamide additive according to the instant invention processed under various conditions.

FIG. 2 is a graph showing the tensile stress at break and tensile stress at break retention for a thermoplastic polyamide composite having from about 2% by weight to about 5% by weight of an oxamide additive when molded and after being aged at 150° C. for 1008 hours.

### DETAILED DESCRIPTION OF THE INVENTION

In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The invention is directed to a novel additive comprising an oxamide with long chains, preferably hydrocarbon chains. This novel additive can be incorporated with a thermoplastic polymer into a thermoplastic polymer composite. Adding the oxamide additive to the thermoplastic polymer modifies the surface of the thermoplastic polymer, thereby increasing the thermoplastic polymer composite's repellant properties. These repellant properties protect the thermoplastic polymer composite so it is not contaminated with contaminants, such as water, oil or dust. This additive can be further tailored by addition of functional groups along the chain to impart additional desired properties. It is desirable that the physical properties of the thermoplastic polymer are maintained even with the addition of the oxamide additive.

As used herein, the term “composite” refers a thermoplastic polymer matrix containing at least one thermoplastic polymer and various additives.

The additive of the instant invention comprises an oxamide additive with a crystallizable long chain. The oxamide additive is based on a dicarboxylic acid diamide of oxalic acid. The oxamide may also be known as ethanediamide or oxalamide. The oxamide additive includes at least one oxamide functional group and at least one crystallizable long chain. The long chain is preferably a hydrocarbon long chain. Alternatively, the long chain can be a fluorohydrocarbon chain or a perfluorocarbon chain.

This long chain can be modified to include desired functional groups on the chain. The functional groups used are dependent upon the final application of the oxamide additive with the long chain and the desired properties of the thermoplastic polymer composite when such additive is incorporated into the thermoplastic polymer.

In addition, the length of the crystallizable long chain as well as the monomers used to form the oxamide additive can be altered to achieve desired properties in the thermoplastic polymer composite. For example, the chain length and the monomers used to form the additive can be altered to achieve the desired melting temperature of the oxamide additive, the crystallinity of the long chain, and the desired properties of the thermoplastic polymer composite such as repellency when the additive is incorporated therein. The water contact angle has been measured as a measure for water repellency and it is believed that this measurement reflects the properties of repellency for dust as well as oil.

The desired melting temperature of the oxamide additive can also be modified. The melting temperature of the oxamides is determined by both amide hydrogen bond and chain length. The melting temperature is testing according to the methods set out in ISO 11357. In general, as chain length increases, the melting temperature of the oxamide decreases due to decrease of hydrogen bonding content. To a certain point, the effectiveness of hydrogen bonding content becomes negligible and the chain length increasingly dominates the melting temperature. At this point, if the chain length increases, then the melting temperature of the oxamides start to increase.

In one embodiment, the chain length of the oxamide is preferably a hydrocarbon long chain of at least C8 or higher in order to achieve a hydrocarbon crystalline structure in the long chain. This hydrocarbon crystalline structure covers the surface of the thermoplastic polymer composite to provide a hydrophobic surface which is repellant to water, dust or oil. In another embodiment, the melting temperature of the oxamide additive should be at least 50° C. or higher, preferably 105° C. or higher, or more preferably 125° C. or higher. The addition of functional groups can be used to increase the melting temperature of the oxamide additive. An example of such a functional group is a diamine.

The interaction between the oxamide additive and the thermoplastic polymer composite is also important. The lack of interaction between the oxamide additive and the thermoplastic polymer composite could lead to less leaching of the oxamide additive and maintain the properties of the thermoplastic polymer composite.

In one embodiment, the long chain is an olefin hydrocarbon chain having a chain length of at least C8. More preferably, the long chain is an olefin hydrocarbon having a chain length of at least C10. In these embodiments, the desired melting temperature of the oxamide additive is in the range of about 50° C. to about 250° C. The melting temperature of the oxamide additive should be at least 50° C. or higher; preferably 105° C. or higher; or more preferably 125° C. or higher.

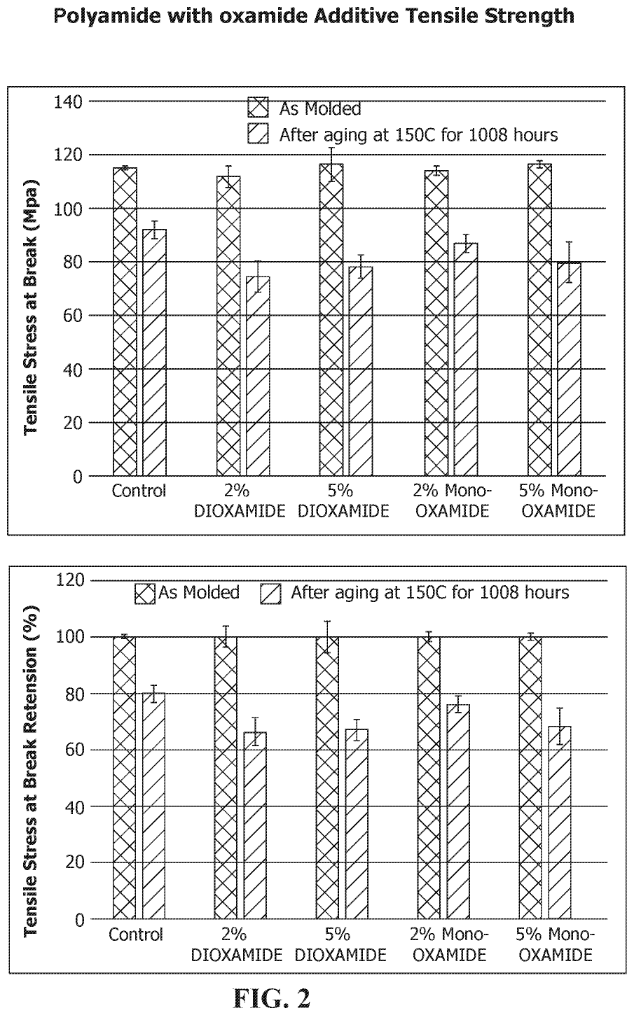

The exact composition of the oxamide additive is dependent upon the thermoplastic polymer composite that the additive will be used in and the desired properties of such thermoplastic polymer composite. Ideally, the thermoplastic polymer and the oxamide additive provide a thermoplastic polymer composite in which a surface repels contaminants such as water, dust or oil. Furthermore, it is desirable to maintain the physical properties of the thermoplastic polymer composite which includes the oxamide additive. These properties may include but are not limited to tensile modulus, tensile strength and stress at break. FIG. 2 shows that the tensile stress at break and tensile stress at break retention for a thermoplastic polymer composite with and without oxamide properties and confirms that the physical properties are maintained by the addition of the oxamide additive.

In another embodiment, the oxamide additive has an oxamide functional group which can react with the thermoplastic polymer as well as a crystallizable long hydrocarbon chain. The oxamide additive can also include various other functional groups on its chain structure, including but not limited to oxalate groups. The oxamide additive should have at least one oxamide structure that can provide interaction between the additive and thermoplastics such as polyamide and polyesters. Some additives could also have an oxalate or oxalic acid functional group that chemically react with other functional groups in thermoplastics such as amine and hydroxyl groups.

The amount of the oxamide additive in the thermoplastic polymer composite is in the range of from about 0.1% to about 10%, including from about 0.1% to about 8%, or from about 0.5% to about 5% by weight of the entire thermoplastic polymer composite.

Thermoplastic polymers that can be used in the thermoplastic polymer composite including an oxamide additive described herein include homopolymers and copolymers. Preferably the thermoplastic polymer composite has high surface energy, such as a polyamide, polyester or polyimide. Examples of other thermoplastic polymers include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxyemethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

Non-limiting examples of large volume commercial thermoplastic polymers include polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

Published literature exists to identify many commercial species of these categories of thermoplastic polymers. Non-limiting examples of specific commercial thermoplastic polymers include acrylonitrile butadiene styrene (ABS), polymethyl methacrylate (PMMA), cellulose acetate, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polypropylene (PP), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN).

In addition to the oxamide additive, the thermoplastic polymer composite may include additional additives conventionally employed in the manufacture of products made from polymers. Suitable additives include pigments, dyes, antistatic agents, foaming agents, plasticizers, binders, radical scavengers, anti-blocking agents, anti-dust agents, antifouling agents, surface active agents, slip aids, optical brighteners, plasticizers, viscosity modifiers, gloss improvers, dispersion stabilizers, UV stabilizers, UV absorbers, antioxidants, lubricity agents, heat stabilizers, hydrolysis stabilizers, cross-linking activators, flame retardants, layered silicates, radio opacifiers, such as barium sulfate, tungsten metal, non-oxide bismuth salts, fillers, colorants, reinforcing agents, adhesion mediators, impact strength modifiers, antimicrobials, and any combination thereof. Such additives may be included in conventional amounts. Preferably, these additional additives are generally in the range of about 0.5 weight % to about 10 weight % of the composition. These can be mixed into the composition in any conventional manner desired.

In another aspect, the invention relates to a process for preparing the polymer composite. The process comprises providing a thermoplastic polymer, and at least one oxamide additive. The thermoplastic polymer and the oxamide additive are mixed together in particulate form using any conventional process to mix materials together. The mixing equipment can be any suitable equipment in the art of mixing concentrated solids. Examples of such suitable equipment include high speed Henschel mixers, ribbon blenders, shakers, extruders and the like. Alternatively, the thermoplastic polymer and the oxamide additive can be heated so that they melt and then be mixed together by melt compounding to form the thermoplastic polymer composite.

The mixing produces the desired extrudable thermoplastic polymer composite which is suitable for melt extrusion to form pellets, films, fibers, shaped products, coextrusions, profile shapes, sheets and other products conventionally produced by employing an extrusion step.

When desired, the thermoplastic polymer composite can be in the form of pellets, shaped products, profile shapes or other products which are later extruded (or re-extruded), blow molded, thermoformed, injection molded or otherwise processed to form final desired products or apparatus. Examples of such include sheets, pipes, and profiles using standard manufacturing techniques for these products. Other applications include sensors, connectors and tubing.

Preferably the thermoplastic polymer composite is used in an electrical connector housing made from such thermoplastic polymer composite wherein the connector housing must repel contaminants. The contaminants may include water, dust or oil. Preferably, the connector housing is made from a polyamide polymer and oxamide additive according to the instant invention.

In yet another embodiment the thermoplastic polymer composite can be formed into a coating. A binder, solvent and/or other additives may also be added to the thermoplastic composite to form a coating. The coating can be prepared by any suitable method for preparing coatings which is dependent upon the all the components used in the coating. Any known method can be used to apply the coating to the surface of an object, including but not limited to printing, brushing, spraying, rolling, spreading, dipping and the like. Generally, the coating is between 10 and 100 microns thick.

### EXAMPLES

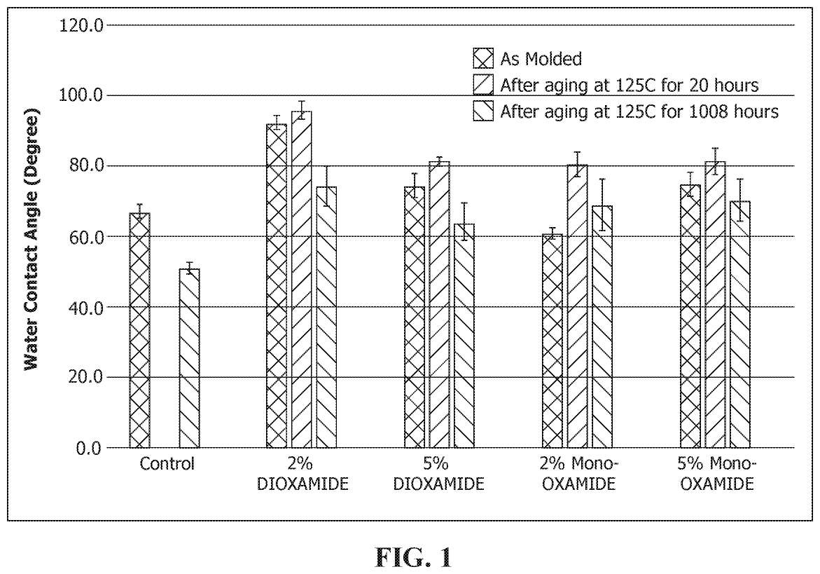

In one example, 2 moles of stearylamine were reacted with 1 mole of diethyloxalate to form an oxamide additive with an amide group compatible with polyamide. The resulting thermoplastic polymer composite has a C18 long chain hydrocarbon as shown in Equation 1, and provides the desired water, oil or dust repellent performance. This result is confirmed by the results in FIG. 1 which shows that the water contact angles of the thermoplastic polymer composite having an oxamide additive are much higher than the control samples which do not include the oxamide additive.

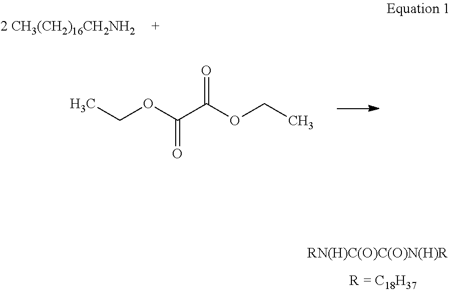

In another example, 2 moles of dioctadecylamine are reacted with 1 mole of diethyloxalate to form an oxamide additive with an amide group compatible with a thermoplastic such as polyamide or polyester. The resulting thermoplastic polymer composite in this example, shown in Equation 2 below provides the desired water, oil or dust repellent performance in the thermoplastic polymer composite.

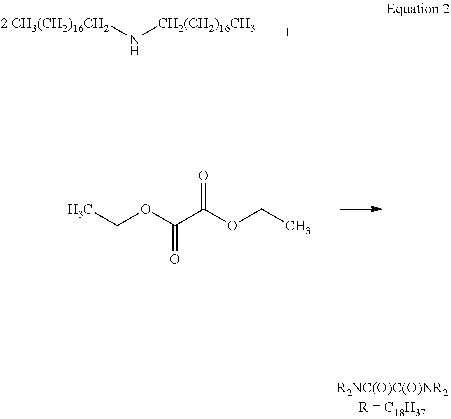

To adjust the compatibility with other thermoplastic polymers as well as the melting temperature of the oxamide additive, the oxamide additive structure can be further adjusted as described. 2 moles of diethyloxalate can be reacted with 1 mole of hexamethylenediamine to form an intermediate as shown in Equation 3. The intermediate is then reacted with 2 moles of stearylamine to form the oxamide additive. It is believed using the intermediate in this manner, the oxamide additive has a potential of having a higher melting temperature and better compatibility with thermoplastic polymers while still providing repellent properties.

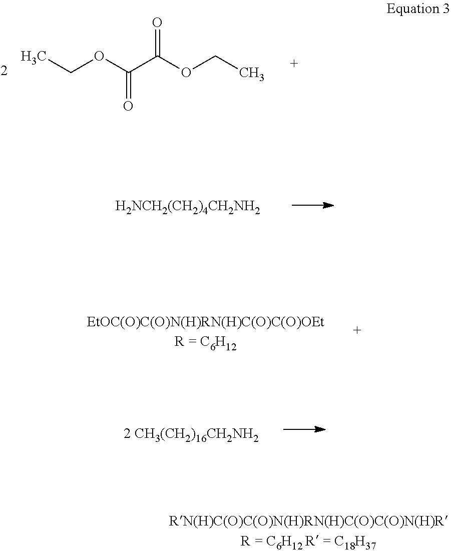

The oxamide additive can optionally also include a reactive oxalate functional group on its chain. The oxalate functional group can react with amine end groups of polyamide or even alcohol end groups of polyesters to form a chemical bond with polyamides or polyesters and further improve their anti-leach performance while maintaining repellence performance.

For example, 1 moles of stearylamine was reacted with 1 mole of diethyloxalate to form an oxamide additive, shown below in Equation 4. This additive is very compatible with polyamide and has the improved anti-leach performance and desired repellence performance.

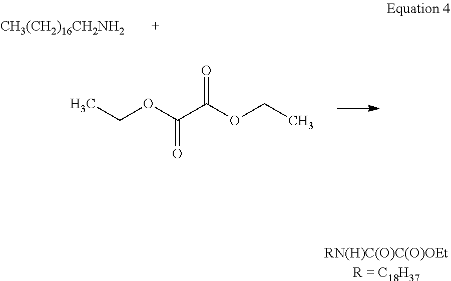

In another example, 1 mole of dioctadecylamine can be reacted with 1 mole of diethyloxalate to form the oxamide additive as shown below in Equation 5. This oxamide additive does not bond as well as others with the thermoplastic polymer because of the lack of the hydrogen in amide group in the additive. However, the oxamide additive has an oxalate functional group which can react with the amine or alcohol end groups of various thermoplastic polymers to form a good chemical bond with the thermoplastic polymer and resulting in the improved water, dust or oil repellence of the thermoplastic polymer composite.

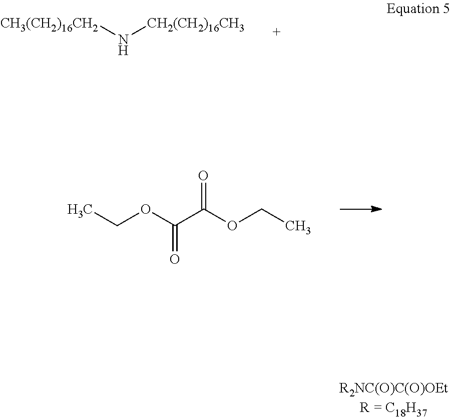

In yet another example, to adjust both the compatibility with polyamides and melting temperature of oxamide additives, the structure can be further modified as described in the Equation 6 below. 2 moles of diethyloxalate can be react with 1 mole of hexamethylenediamine to form an intermediate first. The intermediate is then reacted with 1 mole of stearylamine to form an oxamide additive potentially having a higher melting temperature due to higher oxamide content and better compatibility to the thermoplastic polymer due the reactive oxalate functional group. Ideally, the melting temperature of the oxamide does not exceed the temperature that the thermoplastic polymer and the additive are compounded at.

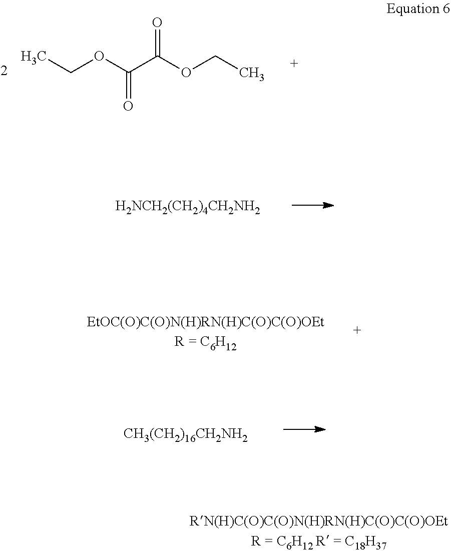

FIG. 1 is a graph showing the water contact angle of various polyamide composites having a range of from 2% by weight to about 5% by weight of an oxamide additive processed under various conditions. The samples of the various polyamide composites were put in an air circulating oven preheated to 125° C. and then soaked for different times. After being aged, the samples were taken from the oven and cooled at room temperature. The water contact angle was measured using the Ramé-hart Contact Angle Goniometer using the method set out in ASTM D5946.

The various polyamide composites were first dried at 80° C. for 4 to 8 hours. The oxamide additive was then dry blended with the dried polyamide resin to form a thermoplastic polymer composite. The thermoplastic polymer composite was injection molded on a 50 ton injection molding machine using the suggested injection molding conditions as below:
Rear temperature: 280 to 310° C.
Middle temperature: 280 to 310° C.
Front temperature: 280 to 310° C.
Nozzle temperature: 280 to 310° C.
Mold temperature: 65 to 95° C.
   The parameters used to process the thermoplastic polymer composite may vary depending upon the actual thermoplastic polymer as well as additive that are used to form the thermoplastic polymer composite.

The molded samples were then aged. The tensile stress at break of the molded sample was measured using an ASTM D638 test. Similarly, the tensile stress at break retention (%) was calculated from the data of tensile stress at break with different aging times. As shown in FIG. 2, the polyamide polymer composite with the oxamide additive which was molded had good tensile stress at break in comparison to the control. Similarly, the polyamide polymer composite had acceptable tensile stress at break retention as compared to the control without the oxamide additive.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An additive for improving the water, oil or dust repellency of a thermoplastic polymer composite comprising an oxamide group and a crystallizable long chain attached to the oxamide group.

2. The additive of claim 1, wherein the long chain is a hydrocarbon chain.

3. The additive of claim 2, wherein the hydrocarbon chain is at least C8 or higher.

4. The additive of claim 1, wherein the long chain is a fluorohydrocarbon.

5. The additive of claim 1, wherein the long chain is a perfluorocarbon.

6. The additive of claim 1, wherein the additive has a melting temperature of at least 50° C. or higher.

7. The additive of claim 1, wherein the additive has a melting temperature of at least 105° C. or higher.

8. The additive of claim 1, wherein the additive has a melting temperature of at least 125° C. or higher.

9. A thermoplastic polymer composite comprising a thermoplastic polymer and an oxamide additive.

10. The thermoplastic polymer composite of claim 9, wherein said oxamide additive comprises an oxamide group and a crystallizable long chain attached to the oxamide group.

11. The thermoplastic polymer composite of claim 9, wherein said thermoplastic polymer is chosen from polyamides, polyimides and polyesters.

12. The thermoplastic polymer composite of claim 9, wherein said thermoplastic polymer is chosen from the group consisting essentially of: include polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

13. The thermoplastic polymer composite of claim 9, wherein the oxamide additive has a melting temperature of at least 50° C or higher.

14. The thermoplastic polymer composite of claim 9, wherein the oxamide additive has a melting temperature of at least 105° C. or higher,

15. The thermoplastic polymer composite of claim 9, wherein said oxamide additive comprises about 0.1 to about 10% by weight: of the entire thermoplastic composite.

16. A electrical connector housing made from a thermoplastic polymer composite wherein the electrical connector housing must repel contaminants, wherein said thermoplastic composite comprises a thermoplastic polymer and an oxamide additive.

17. The electrical connector housing of claim 16, wherein the contaminants are water, dust or oil.

18. The electrical connector housing of claim 16, wherein said thermoplastic polymer is chosen from the group consisting of polyamides, polyimides and polyesters.

19. The electrical connector housing of claim 16, wherein said thermoplastic polymer is a polyamide.

20. The electrical connector housing of claim 16, wherein said oxamide additive comprises an oxamide group and a crystallizable long chain attached to the oxamide group.
